(19) United States
(12) Patent Application Publication
(10) Pub. No.: US 2023/0006941 A1
(43) Pub. Date: Jan. 5, 2023

(54) HYPERVISOR IMPLEMENTED PMTU FUNCTIONALITY AND FRAGMENTATION IN A CLOUD DATACENTER

(71) Applicant: VMware, Inc., Palo Alto, CA (US)

(72) Inventors: Vijai Coimbatore Natarajan, San Jose, CA (US); Ankit Parmar, Santa Clara, CA (US)

(21) Appl. No.: 17/365,960

(22) Filed: Jul. 1, 2021

(51) Int. Cl. H04L 12/805; H04L 12/46; G06F 9/455

(52) U.S. Cl. CPC H04L 47/365; H04L 12/4641; G06F 9/45558; G06F 2009/45595

(57) ABSTRACT

The method of some embodiments controls maximum transmission unit (MTU) size for transmitting data messages of a flow through a gateway of a datacenter. The method, on a host computer operating in the datacenter and executing a source machine for a data message flow, receives an identifier of an MTU size associated with the gateway operating in the datacenter. The method receives, from the source machine, a data message of the flow to be sent through the gateway, where the data message comprises a frame that exceeds the identified MTU size. After determining that the frame includes an indicator specifying that the frame should not be fragmented, the method directs the machine to use smaller size frames in the data messages of the flow. After receiving smaller size frames for the data messages of the flow, the method forwards the data messages to the gateway.

### BACKGROUND

In a datacenter (e.g., a private cloud datacenter operating on a public/provider cloud datacenter), there are several options for machines inside the datacenter to connect to machines outside the datacenter, sometimes called “north-south connectivity” (e.g., namely internet connectivity, provider services connectivity, and on-premise connectivity). Data messages are sent in networks as frames of data. Different network connections allow different maximum transmission unit (MTU) sizes for frames. The internet connectivity path typically has a maximum-supported MTU size of 1500 (e.g., each frame must be at most 1500 bytes). The provider connectivity services and on-premise connectivity paths typically have support for larger frames. Moreover, the datacenter topologies are usually prescriptive topologies (i.e., predefined topologies). The topologies do not typically change with each administrator (i.e., administrator of the public cloud datacenter who operates the private cloud datacenter).

In some prior art systems (e.g., IP4 network systems), when a data message is sent with frames that are larger than the smallest MTU size of any router in the path from the source to the destination of the data message, the first router along the path whose MTU size is exceeded by the frame will either break the frame down into smaller frames that are equal to or less than the MTU size of that router (if the frame does not include an indicator that the frame should not be broken down) or drops the packet and sends a “needs fragmentation” message (e.g., an Internet Control Message Protocol (ICMP)) back to the source machine of the packet. The message includes the MTU size of the router that dropped the packet, so that the source machine of the packet can fragment the data message with fragments at or below the MTU size of the router. In some prior art systems, in order to expedite data message transmission, a path MTU (PMTU) discovery process is performed by a gateway of a datacenter to determine the smallest MTU size of any router, switch, etc., along a network path between the source machine and the destination machine.

The datacenter bring-up (initialization process) is also typically automated, and workflows are usually API driven. Hence, the underlay network connectivity is generally uniform within any given datacenter. In such a scenario, the cloud service application (network manager of the datacenter) in the datacenter that is interfacing with a cloud provider would have settings for the maximum-supported MTU size for each different connectivity option. Usually, for provider connectivity services (e.g., connections to Software as a Service (SaaS)) provided by the provider of the public cloud network, the cloud provider would publish the maximum-supported MTU size for the provider services. For on-premises connectivity (e.g., high-speed connections to other datacenters of the administrator), the administrator would know what is the maximum-supported MTU size for on-premises connectivity.

In the prior art, the PMTU discovery (and fragmentation and re-assembly functionality) for every machine (e.g., virtual machine, container, pod, etc., operating on a host computer of the datacenter) is handled by a gateway (sometimes called an edge device) of the datacenter. The MTU sizes for various uplinks (outgoing connection options) for the gateway would generally be discovered by the gateway using a PMTU discovery process known in the art. Such prior art examples include sending large frames through an uplink with “don't fragment” indicators, receiving replies from intermediate devices along the network path that fragmentation is needed (e.g., an “ICMP-fragmentation needed” packet), sending frames of the indicated size, and repeating the process until a frame is sent that is small enough to pass through each intermediate hop in the path and reach the final destination. The gateway in the prior art is a single device or virtual device that handles data forwarding into and out of the datacenter. Being the sole handler of the PMTU functionality for the datacenter is a large load on the gateway. Therefore, there is a need in the art for a more distributed system for handling the PMTU functionality of a datacenter.

### BRIEF SUMMARY

In a datacenter that sends data messages to uplinks through a gateway of the datacenter, when an administrator knows what the maximum-supported maximum transmission unit (MTU) size is for a particular uplink (e.g., an on-premises (datacenter-to-datacenter) environment or for provider services uplink), then there is no need to do path MTU (PMTU) discovery by sending packets all the way through the on-premises environment or to the provider. The PMTU functionality, fragmentation, and re-assembly can be performed within the datacenter itself. For example, the method of some embodiments provides PMTU functionality, fragmentation, and re-assembly inside hypervisors operating on host computers of the datacenter, rather than having a gateway of the datacenter handle the PMTU functionality, fragmentation, and re-assembly.

The method of some embodiments controls the MTU size for transmitting data messages of a flow through a gateway of a datacenter. The method, on a host computer operating in the datacenter and executing a source machine for a data message flow, receives an identifier of an MTU size associated with the gateway operating in the datacenter. The method receives, from the source machine, a data message of the flow to be sent through the gateway, where the data message comprises a frame that exceeds the identified MTU size. After determining that the frame includes an indicator specifying that the frame should not be fragmented, the method directs the machine to use smaller-size frames in the data messages of the flow. After receiving smaller-size frames for the data messages of the flow, the method forwards the data messages to the gateway. In some embodiments, the gateway has a set of one or more uplink interfaces, and the MTU size is associated with a first uplink interface of the gateway. Some embodiments of the method are performed by a hypervisor of the host computer.

In the method of some embodiments, there are multiple flows, multiple uplinks, and multiple MTU sizes, and the second uplink interface of the gateway is associated with a larger, second MTU size. The method of such embodiments, receives, from the source machine, a data message of a second flow to be sent to the second uplink of the gateway, wherein the data message comprises a frame that exceeds the first MTU size but not the second MTU size. Based on the frame of the received data message of the second flow being smaller than the second MTU size, the method forwards the data messages of the second flow to the gateway for forwarding along the second uplink interface.

Some embodiments have multiple flows sent through the same uplink. The method of such embodiments receives, from the source machine, a data message of a second flow to be forwarded along the first uplink interface. The received data message of the second flow includes a frame that does not exceed the identified MTU size. Based on the frame of the received data message of the second flow being smaller than the MTU size, the method forwards the data messages of the second flow to the gateway for forwarding along the first uplink interface. The first uplink may be an uplink to the internet. In some embodiments, the datacenter is a first datacenter, and the first uplink is a connection to a second datacenter.

In some embodiments, in addition to a flow with an indicator specifying that the frame of the flow should not be fragmented, the method also receives, from the source machine, a data message of a second flow to be sent to the gateway. The received data message of the second flow also includes a frame that exceeds the identified MTU size. The method determines that the frame of the received data message of the second flow does not include an indicator specifying that the frame should not be fragmented. The method divides the data frame of the received data message of the second flow into two or more fragmented data frames smaller than or equal to the MTU size and forwards the fragmented data frames in two or more data messages to the gateway.

The machine, in some embodiments, is one of a virtual machine, a pod, or a container of a container network. The datacenter, in some embodiments, is a cloud data center. The cloud datacenter may be a virtual private cloud (VPC) datacenter operating in a public cloud datacenter. In some such embodiments, the gateway is implemented by a machine of the VPC datacenter. In some such embodiments, the gateway may have an uplink to services of the public cloud datacenter and the MTU size is associated with an uplink to services of the public cloud datacenter.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all of the embodiments described by this document, a full review of the Summary, the Detailed Description, the Drawings, and the Claims is needed. Moreover, the claimed subject matters are not to be limited by the illustrative details in the Summary, the Detailed Description, and the Drawings, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purposes of explanation, several embodiments of the invention are set forth in the following figures.

FIG. 1 illustrates a datacenter of some embodiments.

FIG. 2 conceptually illustrates a process of some embodiments for handling PMTU functionality and fragmentation operations.

FIG. 3 illustrates a fragmentation operation of a source machine sending an oversized frame with a “do not fragment” indicator to a hypervisor.

FIG. 4 illustrates a fragmentation operation of a source machine sending an oversized frame without a “do not fragment” indicator to a hypervisor.

FIG. 5 illustrates a fragmentation operation of a source machine sending a correct-sized frame to a hypervisor.

FIG. 6 conceptually illustrates a process of some embodiments for sending configuration data to the hypervisors of the datacenter.

FIG. 7 illustrates a GUI of some embodiments that allows an administrator to set MTU size values for uplinks associated with a gateway and associate destination addresses with specific uplinks.

FIG. 8 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

In a datacenter that sends data messages to uplinks through a gateway of the datacenter, when an administrator knows what the maximum-supported maximum transmission unit (MTU) size is for a particular uplink, (e.g., an on-premises (datacenter to datacenter) environment or for provider services uplink), then there is no need to do path MTU (PMTU) discovery by sending packets all the way through the on-premises environment or to the provider. The PMTU functionality, fragmentation, and re-assembly can be performed within the datacenter itself. For example, the method of some embodiments executes PMTU functionality, fragmentation, and re-assembly inside hypervisors operating on host computers of the datacenter, rather than having a gateway of the datacenter handle the PMTU functionality, fragmentation, and re-assembly.

The method of some embodiments controls the MTU size for transmitting data messages of a flow through a gateway of a datacenter. The method, on a host computer operating in the datacenter and executing a source machine for a data message flow, receives an identifier of an MTU size associated with the gateway operating in the datacenter. The method receives, from the source machine, a data message of the flow to be sent through the gateway, where the data message comprises a frame that exceeds the identified MTU size. After determining that the frame includes an indicator specifying that the frame should not be fragmented, the method directs the machine to use smaller-size frames in the data messages of the flow. After receiving smaller-size frames for the data messages of the flow, the method forwards the data messages to the gateway. In some embodiments, the gateway has a set of one or more uplink interfaces, and the MTU size is associated with a first uplink interface of the gateway. The method of some embodiments is performed by a hypervisor of the host computer.

In the method of some embodiments, there are multiple flows, multiple uplinks, and multiple MTU sizes, and the second uplink interface of the gateway is associated with a larger, second MTU size. The method of such embodiments, receives, from the source machine, a data message of a second flow to be sent to the second uplink of the gateway, wherein the data message comprises a frame that exceeds the first MTU size but not the second MTU size. Based on the frame of the received data message of the second flow being smaller than the second MTU size, the method forwards the data messages of the second flow to the gateway for forwarding along the second uplink interface.

Some embodiments have multiple flows sent through the same uplink. The method of such embodiments receives, from the source machine, a data message of a second flow to be forwarded along the first uplink interface. The received data message of the second flow includes a frame that does not exceed the identified MTU size. Based on the frame of the received data message of the second flow being smaller than the MTU size, the method forwards the data messages of the second flow to the gateway for forwarding along the first uplink interface. The first uplink may be an uplink to the internet. In some embodiments, the datacenter is a first datacenter and the first uplink is a connection to a second datacenter.

In some embodiments, in addition to a flow with an indicator specifying that the frame of the flow should not be fragmented, the method also receives, from the source machine, a data message of a second flow to be sent to the gateway. The received data message of the second flow also includes a frame that exceeds the identified MTU size. The method determines that the frame of the received data message of the second flow does not include an indicator specifying that the frame should not be fragmented. The method divides the data frame of the received data message of the second flow into two or more fragmented data frames smaller than or equal to the MTU size and forwards the fragmented data frames in two or more data messages to the gateway.

The machine, in some embodiments, is one of a virtual machine, a pod, or a container of a container network. The datacenter, in some embodiments, is a cloud data center. The cloud datacenter may be a virtual private cloud (VPC) datacenter operating in a public cloud datacenter. In some such embodiments, the gateway is implemented by a machine of the VPC datacenter. In some such embodiments, the gateway may have an uplink to services of the public cloud datacenter and the MTU size is associated with an uplink to services of the public cloud datacenter.

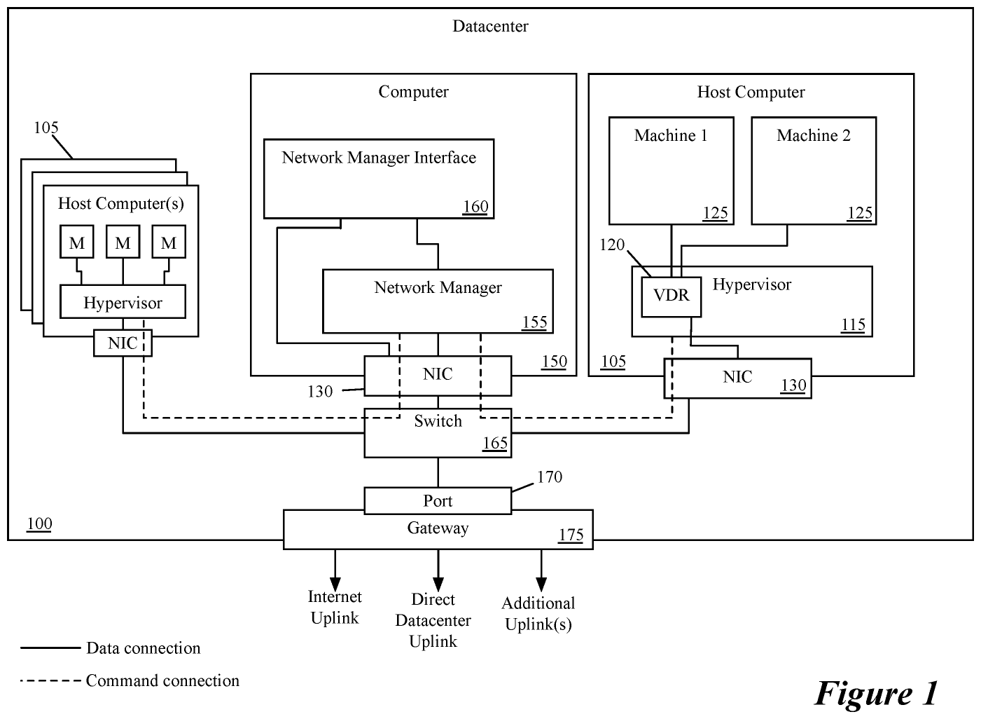

FIG. 1 illustrates a datacenter 100 of some embodiments. The datacenter 100 includes multiple host computers 105, a computer 150 that implements software for controlling the logical elements of the datacenter, and a gateway 175. Each host computer 105 includes a hypervisor 115 with a virtual distributed router 120. Each host computer 105 implements one or more machines 125 (e.g., virtual machines (VMs), containers or pods of a container network, etc.). The computer 150 may be another host computer, a server, or some other physical or virtual device in the datacenter. Computer 150 includes a network manager 155 (sometimes called a “software defined datacenter manager”) and a network manager interface 160. Each computer 105 and 150 has a network interface card 130 that connects to a switch 165 (e.g., a physical or logical switch) of the datacenter 100. The switch 165 routes data messages between the computers 105 and 150 and between the computers 105 and 150 and the gateway 175 through the port 170 (e.g., a physical or logical port) of the gateway 175. The gateway 175 then sends data messages out through one or more uplinks (e.g., an internet uplink, a direct datacenter uplink, a provider services uplink, etc.).

One of ordinary skill in the art will understand that the uplinks in some embodiments are not separate physical connections, but are conceptual descriptions of different types of communications paths that data messages will pass through, given the source and destination addresses of the data messages. In some embodiments, the hypervisor 115 or a component of the hypervisor 115 will maintain a list (or database) of addresses or address ranges that a router, switch, or other element uses to determine which uplink a data message will be sent through based on its destination address and/or some other characteristic of the data message. For example, in some embodiments, the hypervisor 115 or a virtual distributed router (VDR) 120 of the hypervisor 115 performs a policy-based routing (PBR) lookup of route endpoints (e.g., in a list or database supplied by the network manager 155). The PBR lookup is used to determine which “uplink” the data message will travel through based on the destination address (and/or the source address in some embodiments) of the data message flow. In some embodiments, the PBR lookup table includes rules that match both the source and destination endpoints when determining the uplink that applies to a data message. However, in other embodiments that use a PBR lookup table, the source address of the data message is not relevant because whatever the source address is, it will be a source inside the datacenter 100 (e.g., a machine on a host of the datacenter 100) and thus the uplink that a data message flow will use outside the datacenter 100 does not depend on the specific source address of the flow.

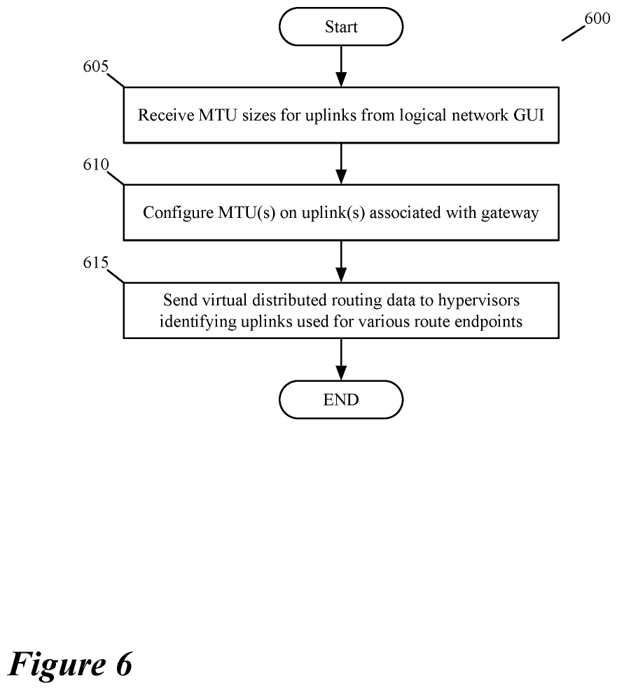

In some embodiments, the PBR lookup is performed using a match/action algorithm on a PBR lookup table (of match criteria and corresponding actions) with the match being determined based on the destination address of a data message frame and/or other characteristics of the data message frame (e.g., a source address of the data message), and the action is to use a particular uplink's MTU size when determining whether the frames of the data message are too big. In other embodiments, the VDR 120 or hypervisor 115 receives specific uplink data for each match, and then uses that uplink data to populate the actions for that match with the MTU size values to use for each match criteria. That is, the PBR lookup table may be populated with MTU size values when data identifying the endpoints of routes and their corresponding uplinks arrives, rather than the uplink itself being stored in the table. In some embodiments, VDR data used to generate the PBR lookup table is provided by a network manager 155. A process for providing VDR data will be further described below with respect to FIG. 6.

An internet uplink's MTU size will generally remain at 1500, the standard MTU size for the internet. In some embodiments, the datacenter 100 operates as a virtual private cloud (VPC) operating as a logically isolated section of a public cloud datacenter (e.g., an Amazon Web Services (AWS) datacenter). In such embodiments, the public cloud datacenter may offer various SaaS options (e.g., data backup or other storage, security, etc.). In some cases, an uplink to the provider services may have a higher (or lower) MTU size than the internet uplink (e.g., an MTU size of 8,000, 9,000, or some other value). In some datacenters, the datacenter will include a high-speed uplink to one or more other datacenters (e.g., other private datacenters on other VPCs of the public cloud datacenter, other datacenters elsewhere in a different building, city, state, etc.). These high-speed links are referred to as on-premises links and may also have a higher (or lower) MTU size than the internet uplink (e.g., an MTU size of 8,000, 9,000, or some other value).

The hypervisor 115 is computer software, firmware or hardware operating on a host computer 105 that creates and runs machines 125 on the host (e.g., virtual machines, containers, pods, etc.). In the embodiment of FIG. 1, the hypervisor 115 includes a VDR 120 that routes data messages between machines 125 within the host computer 105 and between the machines 125 and the NIC 130 of the host computer 105. The hypervisors 115 of some embodiments of the invention are configured by commands from a network manager 155.

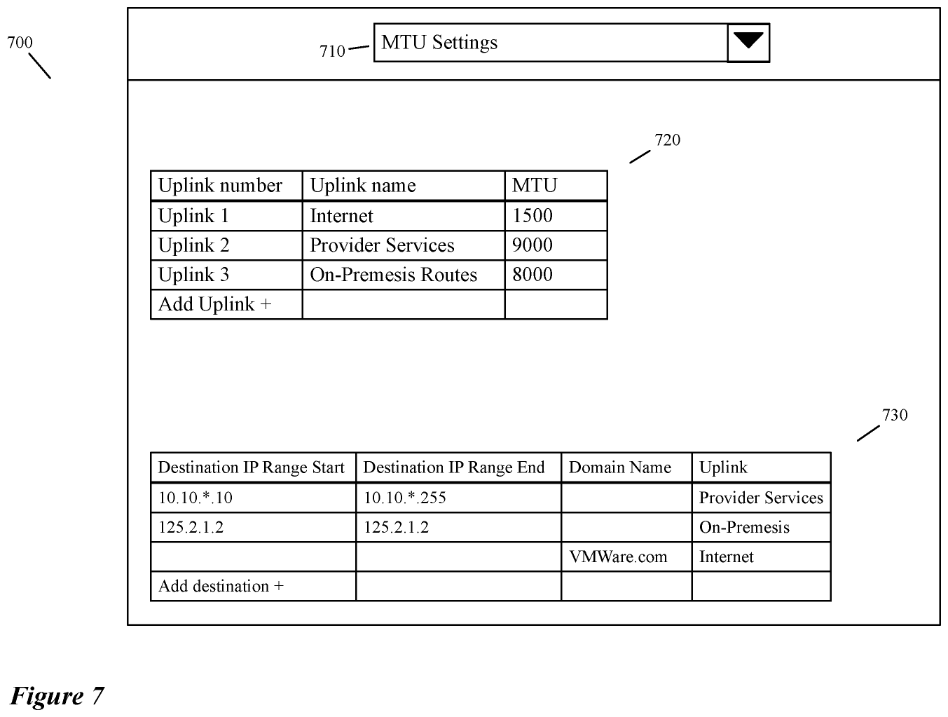

The network manager 155 provides commands to network components of the datacenter 100 to implement logical operations of the datacenter (e.g., implement machines on the host computers, change settings on hypervisors, etc.). The network manager 155 receives instructions from the network manager interface 160 that provides a graphical user interface (GUI) to an administrator of the datacenter 100 and receives commands and/or data input from the datacenter administrator. In some embodiments, this GUI is provided through a web browser used by a datacenter administrator (e.g., at a separate location from the datacenter 100). In other embodiments, a dedicated application at the administrator's location displays data received from the network manager interface 160, receives the administrator's commands/data, and sends the commands/data through the GUI to the network manager 155 through the network manager interface 160. Such a GUI will be further described below with respect to FIG. 7.

The received commands in some embodiments include commands to the hypervisors 115, of FIG. 1, to supply MTU size values for one or more uplinks of the gateway 175. The hypervisor 115 then ensures that frames of data messages sent to the gateway 175 are smaller than or equal to the MTU size of the uplink that the data messages are being sent through. In FIG. 1, the command connections are illustrated separately from the data connections for clarity, but one of ordinary skill in the art will understand that the command messages may be sent, part way or entirely, on communications routes (e.g., physical or virtual connections) that are used by data messages.

In some embodiments of the invention, the hypervisors 115 receive an MTU size for each uplink of the gateway 175 and configure the VDRs 120 to perform a PMTU process that ensures that packets sent to an uplink of the gateway 175 are equal to or smaller in size than the configured MTU size for that uplink. In the illustrated embodiment, the VDR 120 is part of the hypervisor 115, however, in other embodiments, the VDR 120 is implemented separately from the hypervisor 115. In such embodiments, the VDR 120 may be configured by the hypervisor 115, by the network manager 155 directly, or by some other system.

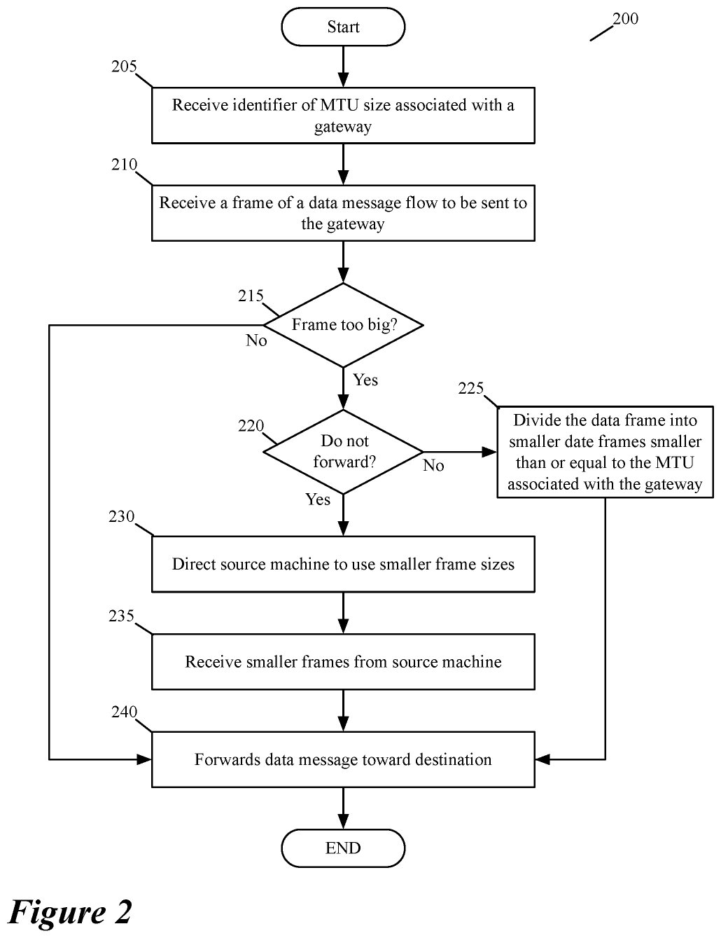

After being configured, the VDR 120 in some embodiments receives data messages made of multiple frames of data from the machines 125. The VDR 120 then ensures that the frames of the data messages sent to the gateway 175 are equal to or smaller in size (e.g., number of bytes) than the configured MTU size for the uplink through which the data message is being sent. A process of some embodiments for ensuring that a data message uses frames equal to or smaller in size than the configured MTU size for the uplink that the data message is being sent through is described in FIG. 2.

The gateway 175 receives the data message frames from the machines 125 on the host computers 105 and sends the data out of the datacenter 100 through a communications link (e.g., a physical or virtual router, etc.). The gateway 175 of some embodiments is hardware, software, firmware, or some combination of the above. In some embodiments, the gateway 175 may be implemented as a machine or on a machine of a host computer. One of ordinary skill in the art will understand that sending a data message out on a particular uplink does not mean sending it on a physically or logically separate connection from the gateway, but rather the uplinks are descriptions of the type of network connection that the data messages will pass through after they leave the datacenter 100.

FIG. 2 conceptually illustrates a process 200 of some embodiments for handling PMTU functionality and fragmentation operations. In some embodiments, the process 200 is performed by a hypervisor operating on a host computer (e.g., by one or more modules or sets of software code that implement the hypervisor). In other embodiments, the process 200 is performed by a different element or elements operating on the host computer. The process 200 begins by receiving (at 205) an identifier of an MTU size associated with a gateway operating in the datacenter. The MTU size in some embodiments is received from a network manager. In some embodiments, the MTU size for each uplink is pre-configured in the network manager, in other embodiments, the MTU size is specified by an administrator of the datacenter (e.g., through a GUI used with the network manager).

The process 200 then receives (at 210), from the source machine, a frame of a data message of a flow to be sent to the gateway. In some embodiments, the data message is received at a VDR of a hypervisor from a virtual MC (VNIC) of the source machine. The process 200 then determines (at 215) whether the frame is too big. That is, whether the size of the frame in bytes exceeds the configured MTU size for the uplink that the data message will use. As mentioned above, the uplink is not a physical connection out of the datacenter, but instead specifies which of multiple classifications of network routes the data message will take when being routed to its destination address.

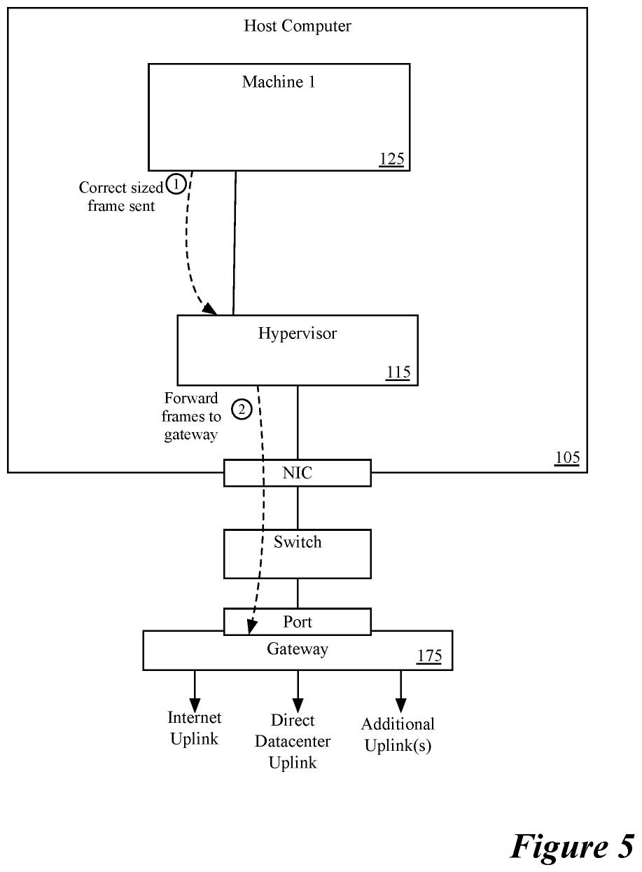

In some embodiments, determining whether a frame is too big includes determining which uplink the frame will be sent through (e.g., by performing a PBR lookup to compare the destination address of the data message flow to addresses in a list or database of uplinks used when sending data messages to particular addresses or ranges of addresses and/or by using other information in the data frame). If the frame is determined (at 215) to not be too big (i.e., to be equal in size to or smaller than the MTU size of the uplink that the frame is being sent through), the process 200 forwards (at 240) the data message toward its destination (without fragmenting the frames of the data message or instructing the source machine to fragment the frames). An illustration of this scenario will be further described below with respect to FIG. 5.

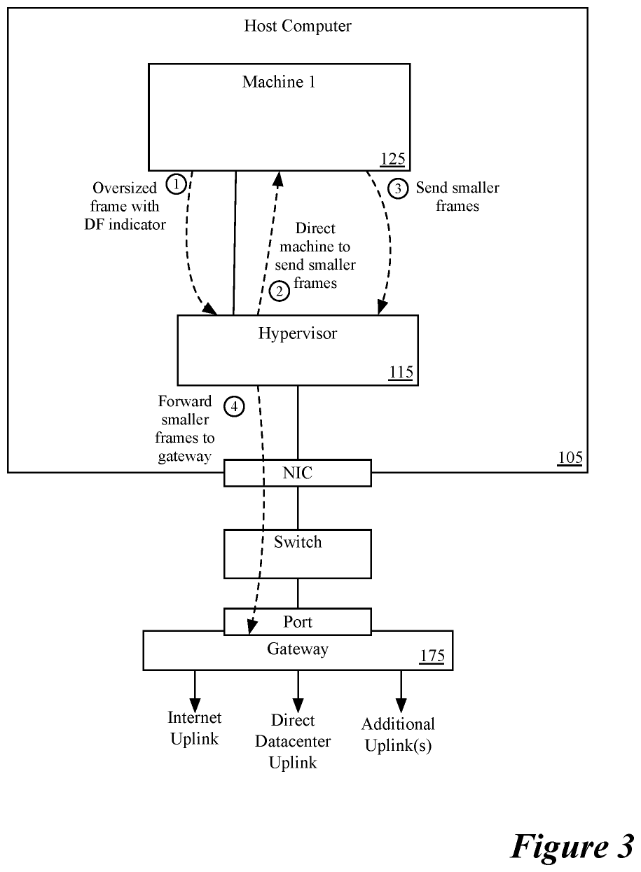

If the frame of the data message is determined (at 215) to be too big for the uplink it will use, then the process 200 determines (at 220) whether a “do not fragment” indicator is set for the frame. In some embodiments, the “do not fragment” indicator is a specific bit or byte in the data message frame, sometimes called a “DF bit” or just a “DF.” If the “do not fragment” indicator is in the frame, then the process 200 directs (at 230) the source machine to use smaller frame sizes. An illustration of this scenario will be further described below by reference to FIG. 3. The direction includes in indicator of the MTU size for the source machine to use. The process 200 then receives (at 235) the data message broken down into smaller frames by the source machine. The process 200 then forwards (at 240) the data message (now broken into smaller frames) towards its destination. The process 200 then ends.

Operation 235 is provided for clarity, however, one of ordinary skill in the art will understand that operation 235 in practice may be performed as operations 210 and 215 (with frames that are not too big). That is, operation 235 should only need to be performed once per data message flow as the source machine should subsequently break all data messages of that flow down to the specified MTU size (or smaller). As all subsequent (smaller) frames of the data messages of that flow will be received by the hypervisor in the same way as operation 210, the process 200 will then determine at operation 215 that the packets (broken into smaller frames than the original frame) are not too big. In some embodiments, the configured MTU size may change under some circumstances, so that a previously acceptable frame size is found to be too big, or the source machine may lose a record of the required frame size for some reason, so in some embodiments, all frames are checked to determine whether they are too big for the then current MTU size of the uplink.

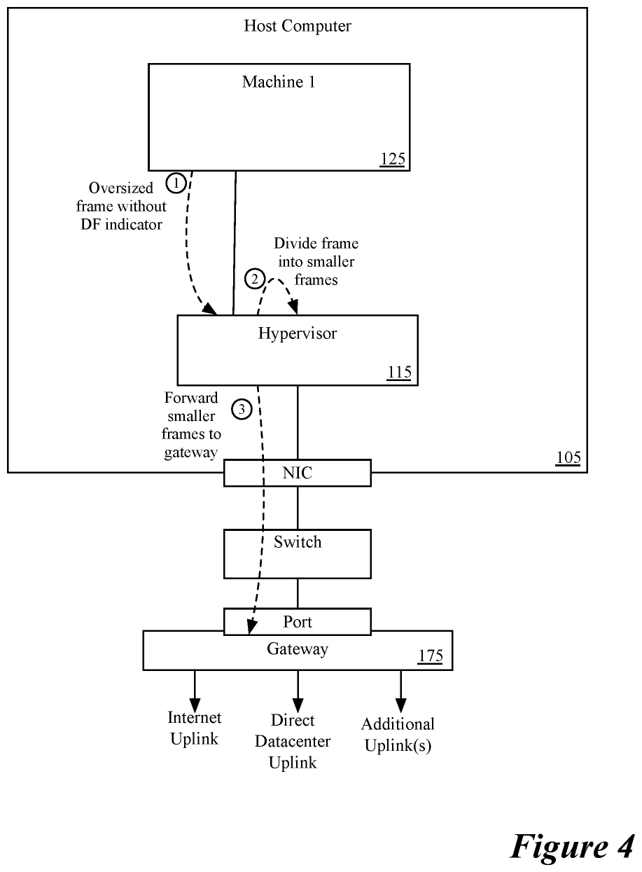

If the “do not fragment” indicator is not in the frame, then the process 200 divides (at 225) the frame of the data message into frames smaller than or equal to the MTU size. An illustration of this scenario will be further described below with respect to FIG. 4. The process 200 then forwards (at 240) the data message (now broken into smaller frames) towards its destination. The process 200 then ends. Since the division is performed by the hypervisor (or the VDR of the hypervisor) in some embodiments, the process 200 will be performed on all frames of the data message flow. The process 200 is performed in the datacenter before the fragmented frames are sent out; however, one of ordinary skill in the art will realize that either a forwarding element along the path the frames take to the destination (or the destination machine itself) re-assembles the fragmented frames into the original frames (or into the original data message).

One of ordinary skill in the art will notice that the process 200 does not include a PMTU discovery operation such as that found in the prior art. In the prior art, one or more frames must be sent from either a source machine or some intermediate forwarding element (e.g., physical or virtual router, physical or virtual switch, physical or virtual gateway, etc.) to the destination in order to discover whether any of the intermediate forwarding elements have an MTU size that is smaller than a particular frame size. In process 200, the MTU size is defined at a local element of the database (e.g., provided in a GUI by a user). In such a process, no packets need to be sent out of the datacenter in order to determine the MTU size for the route that the data message will be sent through.

However, in some embodiments, the processes of the present invention work in concert with existing PMTU discovery systems. For example, in a case in which the MTU size for a particular set of endpoints (source and destination machines) is not defined in the received data used to generate the PBR lookup table, the hypervisors, VDRs, or gateways may perform a PMTU discovery for that particular set of endpoints. In such embodiments, the present invention still reduces the workload of discovering the PMTU for the sets of endpoints that are defined in the received data. In other embodiments, the hypervisors (or VDRs) use a default MTU size (e.g., the typical internet MTU size of 1500) for endpoint values that do not match any of the PBR lookup table entries. Finally, there may be situations in which the hypervisor has incorrect values for the MTU size of a particular uplink or about whether a particular uplink applies to a particular set of endpoints. In such situations, frames sent out in operation 240 of process 200 may be dropped by forwarding elements along the route to the destination address, with the forwarding elements sending ICMP messages back to the datacenter. In such cases, the prior art PMTU discovery process might be implemented for those pairs of endpoints while the present invention would apply to all endpoints with correctly-identified MTU size values.

FIG. 3 illustrates a fragmentation operation of a source machine sending an oversized frame with a “do not fragment” indicator to a hypervisor. First, a source machine 125 on a host 105 sends an oversized frame (e.g., a frame larger than the MTU size of the uplink that the data message that the frame is part of is being sent through) with a “do not fragment” indicator to the hypervisor 115 of the host 105. Second, the hypervisor 115 directs the machine 125 to send smaller frames. In some embodiments, this direction is via an ICMP message that also specifies the MTU size for frames to be sent. A VDR of the hypervisor 115 performs this operation in some embodiments. Third, the source machine 125 sends the data message again, with frames equal to or smaller than the MTU size indicated in the ICMP. Fourth, the hypervisor 115 forwards the smaller frames to the gateway 175 so that the gateway 175 can send the frames out of the datacenter.

FIG. 4 illustrates a fragmentation operation of a source machine sending an oversized frame without a “do not fragment” indicator to a hypervisor. First, a source machine 125 on a host 105 sends an oversized frame (e.g., a frame larger than the MTU size of the uplink that the data message that the frame is part of is being sent through) without a “do not fragment” indicator to the hypervisor 115 of the host 105. Second, the hypervisor 115 divides the oversized frame into smaller frames (e.g., equal to or smaller than the MTU size). A VDR of the hypervisor 115 performs this operation in some embodiments. Third, the hypervisor 115 forwards the smaller frames to the gateway 175 so that the gateway 175 can send the frames out of the datacenter.

FIG. 5 illustrates a fragmentation operation of a source machine sending a correct-sized frame to a hypervisor. First, a source machine 125 on a host 105 sends the correct-sized frame (e.g., a frame equal in size or smaller than the MTU size of the uplink that the data message that the frame is part of is being sent through). Because no action is needed to fragment the packet, the hypervisor 115 does not need to determine whether the frame has a “do not fragment” indicator. Second, the hypervisor 115 forwards the frames to the gateway 175 so that the gateway 175 can send the frames out of the datacenter.

FIG. 6 conceptually illustrates a process 600 of some embodiments for sending configuration data to the hypervisors of the datacenter. In some embodiments, the process 600 is performed by a network manager. The process 600 receives (at 605) MTU sizes for uplinks of a datacenter supplied by a user through a GUI of a network manager interface. Such a GUI will be further described below with respect to FIG. 7. The process 600 then configures (at 610) the MTU sizes for the uplinks associated with the gateway. The process 600 then sends (at 615) virtual distributed routing data to the hypervisors of the host computers of the datacenter. The virtual distributed routing data defines what uplinks are used according to the route endpoints. In some embodiments, these definitions may identify uplinks by reference to individual source/destination address pairs, ranges of destination addresses and/or source addresses, or some combination of individual destination address pairs. As mentioned above, the virtual distributed routing data may be used by the hypervisors or VDRs in some embodiments to generate a PBR lookup table once the VDR or hypervisor receives the VDR data.

FIG. 7 illustrates a GUI 700 of some embodiments that allows an administrator to set MTU size values for uplinks associated with a gateway and associate destination addresses with specific uplinks. In some embodiments the GUI 700 is displayed in a web browser, in other embodiments the GUI 700 is displayed by a dedicated application. GUI 700 includes an interface selector 710, an uplink definition control 720, and a VDR data input control 730. The interface selector 710 receives input (e.g., a click on a pull-down menu icon from a control device such as a mouse) from an administrator to switch from the MTU value control interface to controls for other aspects of the datacenter.

The uplink definition control 720 receives input from an administrator to edit existing uplink definitions (e.g., by receiving a click from a control device on a field and receiving input from a keyboard to change the value in the field). The uplink definition control 720 receives input to change the name or MTU value for an uplink or add new uplink names and provide MTU values for the new uplinks.

The VDR data input control 730 receives IP addresses or domain names of destinations and the associated uplinks to use for those destinations. In the illustrated embodiments, these destination addresses may be a single address, a range of addresses, a range that includes wildcards (here the asterisk), or may omit an IP address in favor of a domain name. One of ordinary skill in the art will understand that the GUI 700 is only one example of GUIs that may be used in some embodiments and that GUIs of other embodiments may have more controls, fewer controls, or different controls from GUI 700.

Many of the above-described features and applications are implemented as software processes that are specified as a set of instructions recorded on a computer-readable storage medium (also referred to as computer-readable medium). When these instructions are executed by one or more processing unit(s) (e.g., one or more processors, cores of processors, or other processing units), they cause the processing unit(s) to perform the actions indicated in the instructions. Examples of computer-readable media include, but are not limited to, CD-ROMs, flash drives, RAM chips, hard drives, EPROMs, etc. The computer-readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

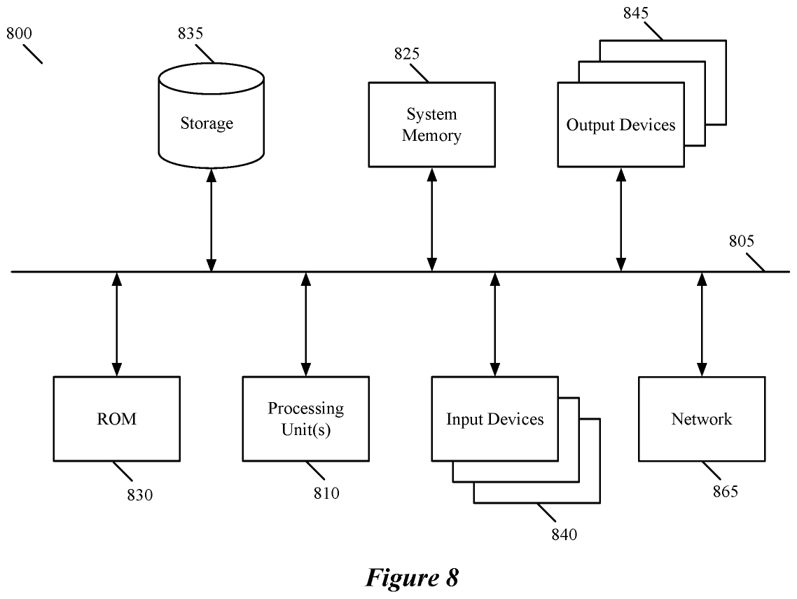

FIG. 8 conceptually illustrates a computer system 800 with which some embodiments of the invention are implemented. The computer system 800 can be used to implement any of the above-described hosts, controllers, gateway, and edge forwarding elements. As such, it can be used to execute any of the above-described processes. This computer system 800 includes various types of non-transitory machine-readable media and interfaces for various other types of machine-readable media. Computer system 800 includes a bus 805, processing unit(s) 810, a system memory 825, a read-only memory 830, a permanent storage device 835, input devices 840, and output devices 845.

The bus 805 collectively represents all system, peripheral, and chipset buses that communicatively connect the numerous internal devices of the computer system 800. For instance, the bus 805 communicatively connects the processing unit(s) 810 with the read-only memory 830, the system memory 825, and the permanent storage device 835.

From these various memory units, the processing unit(s) 810 retrieve instructions to execute and data to process in order to execute the processes of the invention. The processing unit(s) may be a single processor or a multi-core processor in different embodiments. The read-only-memory (ROM) 830 stores static data and instructions that are needed by the processing unit(s) 810 and other modules of the computer system. The permanent storage device 835, on the other hand, is a read-and-write memory device. This device is a non-volatile memory unit that stores instructions and data even when the computer system 800 is off. Some embodiments of the invention use a mass-storage device (such as a magnetic or optical disk and its corresponding disk drive) as the permanent storage device 835.

Other embodiments use a removable storage device (such as a floppy disk, flash drive, etc.) as the permanent storage device 835. Like the permanent storage device 835, the system memory 825 is a read-and-write memory device. However, unlike storage device 835, the system memory 825 is a volatile read-and-write memory, such as random access memory. The system memory 825 stores some of the instructions and data that the processor needs at runtime. In some embodiments, the invention's processes are stored in the system memory 825, the permanent storage device 835, and/or the read-only memory 830. From these various memory units, the processing unit(s) 810 retrieve instructions to execute and data to process in order to execute the processes of some embodiments.

The bus 805 also connects to the input and output devices 840 and 845. The input devices 840 enable the user to communicate information and select commands to the computer system 800. The input devices 840 include alphanumeric keyboards and pointing devices (also called “cursor control devices”). The output devices 845 display images generated by the computer system 800. The output devices 845 include printers and display devices, such as cathode ray tubes (CRT) or liquid crystal displays (LCD). Some embodiments include devices such as touchscreens that function as both input and output devices 840 and 845.

Finally, as shown in FIG. 8, bus 805 also couples computer system 800 to a network 865 through a network adapter (not shown). In this manner, the computer 800 can be a part of a network of computers (such as a local area network (“LAN”), a wide area network (“WAN”), or an Intranet), or a network of networks (such as the Internet). Any or all components of computer system 800 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessors or multi-core processors that execute software, some embodiments are performed by one or more integrated circuits, such as application-specific integrated circuits (ASICs) or field-programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms “display” or “displaying” mean displaying on an electronic device. As used in this specification, the terms “computer-readable medium,” “computer-readable media,” and “machine-readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. For instance, several of the above-described embodiments deploy gateways in public cloud datacenters. However, in other embodiments, the gateways are deployed in a third-party's private cloud datacenters (e.g., datacenters that the third-party uses to deploy cloud gateways for different entities in order to deploy virtual networks for these entities). Thus, one of ordinary skill in the art would understand that the invention is not to be limited by the foregoing illustrative details, but rather is to be defined by the appended claims.

1. A method of controlling maximum transmission unit (MTU) size for transmitting data messages of a flow through a gateway of a datacenter, the method comprising:
on a host computer operating in the datacenter and executing a source machine for a data message flow:
receiving an identifier of an MTU size associated with the gateway operating in the datacenter;
receiving, from the source machine, a data message of the flow to be sent through the gateway, wherein the data message comprises a frame that exceeds the identified MTU size;
after determining that the frame comprises an indicator specifying that the frame should not be fragmented, directing the machine to use smaller size frames in the data messages of the flow; and
after receiving smaller size frames for the data messages of the flow, forwarding the data messages through the gateway.

2. The method of claim 1, wherein the gateway has a set of one or more uplink interfaces, and the MTU size is associated with a first uplink interface of the gateway.

3. The method of claim 2, wherein the flow is a first flow, the MTU size is a first MTU size, and a second uplink interface of the gateway is associated with a larger, second MTU size, the method further comprising:
receiving, from the source machine, a data message of a second flow to be sent to the second uplink of the gateway, wherein the data message comprises a frame that exceeds the first MTU size but not the second MTU size; and
based on the frame of the received data message of the second flow being smaller than the second MTU size, forwarding the data messages of the second flow to the gateway for forwarding along the second uplink interface.

4. The method of claim 2, wherein the flow is a first flow, the method comprising:
receiving, from the source machine, a data message of a second flow to be forwarded along the first uplink interface, wherein the received data message of the second flow comprises a frame that does not exceed the identified MTU size;
based on the frame of the received data message of the second flow being smaller than the MTU size, forwarding the data messages of the second flow to the gateway for forwarding along the first uplink interface.

5. The method of claim 2, wherein the first uplink is an uplink to the internet.

6. The method of claim 2, wherein the datacenter is a first datacenter and the first uplink is a connection to a second datacenter.

7. The method of claim 1 wherein the flow is a first flow, the method further comprising:
on the host computer:
receiving, from the source machine, a data message of a second flow to be sent through the gateway, wherein the received data message of the second flow comprises a frame that exceeds the identified MTU size;
determining that the frame of the received data message of the second flow does not comprise an indicator specifying that the frame should not be fragmented;
dividing the data frame of the received data message of the second flow into two or more fragmented data frames smaller than or equal to the MTU size and forwarding the fragmented data frames in two or more data messages to the gateway.

8. The method of claim 1, wherein the machine is one of a virtual machine, a pod, or a container of a container network.

9. The method of claim 1, wherein the datacenter is a cloud data center.

10. The method of claim 9, wherein the cloud datacenter is a virtual private cloud (VPC) datacenter operating in a public cloud datacenter.

11. The method of claim 10, wherein the gateway is implemented by a machine of the VPC datacenter.

12. The method of claim 10, wherein the gateway has an uplink to services of the public cloud datacenter and the MTU size is associated with an uplink to services of the public cloud datacenter.

13. The method of claim 1, wherein receiving the identifier, receiving the data message, determining that the frame comprises an indicator, receiving smaller size frames, and forwarding the data messages to the gateway are performed at a hypervisor of the host computer.

14. A non-transitory machine readable medium storing a program which, when executed by at least one processing units of a host computer operating in a datacenter, controls maximum transmission unit (MTU) size for transmitting data messages of a flow through a gateway of the datacenter, the program comprising sets of instructions for:
receiving an identifier of an MTU size associated with the gateway operating in the datacenter;
receiving, from a source machine executed by the host computer, a data message of the flow to be sent through the gateway, wherein the data message comprises a frame that exceeds the identified MTU size;
after determining that the frame comprises an indicator specifying that the frame should not be fragmented, directing the machine to use smaller size frames in the data messages of the flow; and
after receiving smaller size frames for the data messages of the flow, forwarding the data messages through the gateway.

15. The non-transitory machine readable medium of claim 14, wherein the gateway has a set of one or more uplink interfaces, and the MTU size is associated with a first uplink interface of the gateway.

16. The non-transitory machine readable medium of claim 15, wherein the flow is a first flow, the MTU size is a first MTU size, and a second uplink interface of the gateway is associated with a larger, second MTU size, the program further comprising sets of instructions for:
receiving, from the source machine, a data message of a second flow to be sent to the second uplink of the gateway, wherein the data message comprises a frame that exceeds the first MTU size but not the second MTU size; and
based on the frame of the received data message of the second flow being smaller than the second MTU size, forwarding the data messages of the second flow to the gateway for forwarding along the second uplink interface.

17. The non-transitory machine readable medium of claim 15, wherein the flow is a first flow, the program further comprising sets of instructions for:
receiving, from the source machine, a data message of a second flow to be forwarded along the first uplink interface, wherein the received data message of the second flow comprises a frame that does not exceed the identified MTU size;
based on the frame of the received data message of the second flow being smaller than the MTU size, forwarding the data messages of the second flow to the gateway for forwarding along the first uplink interface.

18. The non-transitory machine readable medium of claim 15, wherein the first uplink is an uplink to the internet.

19. The non-transitory machine readable medium of claim 15, wherein the datacenter is a first datacenter and the first uplink is a connection to a second datacenter.

20. The non-transitory machine readable medium of claim 14 wherein the flow is a first flow, the program further comprising sets of instructions for:
on the host computer:
receiving, from the source machine, a data message of a second flow to be sent through the gateway, wherein the received data message of the second flow comprises a frame that exceeds the identified MTU size;
determining that the frame of the received data message of the second flow does not comprise an indicator specifying that the frame should not be fragmented;
dividing the data frame of the received data message of the second flow into two or more fragmented data frames smaller than or equal to the MTU size and forwarding the fragmented data frames in two or more data messages to the gateway.
